(19) United States
(12) Patent Application Publication
(10) Pub. No.: US 2017/0053453 A1
(43) Pub. Date: Feb. 23, 2017

(54) AVIONIC SYSTEM COMPRISING MEANS FOR DESIGNATING AND MARKING LAND

(71) Applicant: THALES, Courbevoie (FR)

(72) Inventors: Cecile ANDRE, Bordeaux (FR); Xavier SERVANTIE, Pessac (FR); Laurent LALUQUE, Bordeaux (FR)

(21) Appl. No.: 15/307,804

(22) PCT Filed: Apr. 27, 2015
(86) PCT No.: PCT/EP2015/059006

§ 371 Date: Oct. 28, 2016

(30) Foreign Application Priority Data
Apr. 30, 2014 (FR) 14/01006

(51) Int. Cl. G06T 19/00; G01C 23/00; G02B 27/00; G01C 21/00; G06F 3/01; G02B 27/01

(52) U.S. Cl. CPC G06T 19/006; G06F 3/012; G02B 27/017; G02B 27/0093; G01C 21/00; G01C 23/00; G02B 2027/0141; G02B 2027/014; F41G 3/225

(57) ABSTRACT

The general field of the invention is that of avionics systems intended to be used on aircraft in flight above a terrain. The avionics system comprises a display system and a navigation system. The display system comprises a head support equipped with a display device capable of generating images overlaid on said terrain, and a system for detecting posture of said helmet. The display system according to the invention comprises means for displaying a marking symbol in the display device, said symbol determining a given direction. The navigation system comprises geolocation means for said aircraft, a database of cartographic data representative of said terrain and computation means making it possible to determine the location of the area of the terrain arranged at the intersection of said given direction with said terrain, and means for recording and processing said location in the navigation system.

The field of the invention is that of avionics systems embedded on aircraft comprising a display system mounted on the head of the user. More specifically, the aircraft concerned are helicopters.

Currently, on aircraft, there are no simple means for designating and marking a point of interest situated on a terrain being flown over. The only means for the pilot is to correlate his or her view of the outside landscape with cartographic information relying on environmental indices such as the presence of roads, rivers or works of art. This point of interest can have multiple uses. It can serve as homing point for the aircraft, as weigh point in the flight plan, etc. In military applications, it is possible to use laser pointers to mark a point of interest but these present ocular safety risks and, furthermore, are not georeferenced.

The helmet or head display systems have been commonly used for aeronautical applications for several decades. A helmet display system mainly comprises two subassemblies.

The first subassembly is a helmet equipped with a display system projecting, toward the eye or the eyes of the user, a collimated image overlaid on the outside. A helmet should be understood to be a head protection structure, said structure bearing a certain number of speech or display or detection devices. A headset should be understood to be a structure bearing a certain number of speech or display or detection devices and not necessarily providing a head protection function. The system according to the invention can be equally a helmet or a head support.

The second subassembly is a system for detecting posture of the helmet making it possible to identify in space, relative to a known reference frame, generally linked to an aircraft, the position and the orientation of the helmet. The main function of the helmet display system is to be able to present, overlaid on the outside landscape, so-called “conformal” information, that is to say information displayed virtually in the exact direction that it would occupy in the outside landscape. Thus, if the system displays a video image deriving from a sensor and comprising a certain number of objects, the objects represented in this image are overlaid exactly on the objects present on the terrain.

The embedded navigation systems comprise databases of cartographic data representative of the terrain being flown over. These are coupled to geolocation systems so that the aircraft has a perfect knowledge of its position above the terrain being flown over.

The object of the invention is to couple a helmet or a head display system to a navigation system so as to be able to designate and locate a point of interest simply and accurately. More specifically, the subject of the invention is an avionics system intended to be used on aircraft in flight above a terrain, said avionics system comprising a display system and a navigation system,
said display system comprising at least one head support equipped with a display device capable of generating images overlaid on said terrain, and a system for detecting posture of said support in said aircraft;
said navigation system comprising at least geolocation means for said aircraft, and a database of cartographic data representative of said terrain;
   characterized in that:
the display system comprises means for displaying a marking symbol in the display device, said symbol determining a given direction;
the navigation system comprises computation means making it possible to determine the location of the area of the terrain arranged at the intersection of said given direction with said terrain, and means for recording and processing said location in the navigation system.

Advantageously, the processing means determine the information on position, altitude and distance to the aircraft from the located terrain area, said information being displayed in the display device at the level of the marking symbol.

Advantageously, the display system comprises marking validation means, the graphic representation of the marking symbol being modified after validation, said marking system being associated, after validation, with said located terrain area.

Advantageously, when the located terrain area is validated, the navigation system inserts it into a flight plan.

Advantageously, when the located terrain area is validated, the navigation system computes a homing trajectory to said located terrain area.

Advantageously, when the located terrain area is validated, the navigation system displays it in at least one cartographic representation of the terrain being flown over of a second display device of the display system.

The invention will be better understood and other advantages will become apparent on reading the following description given in a nonlimiting manner and using the attached figures in which:

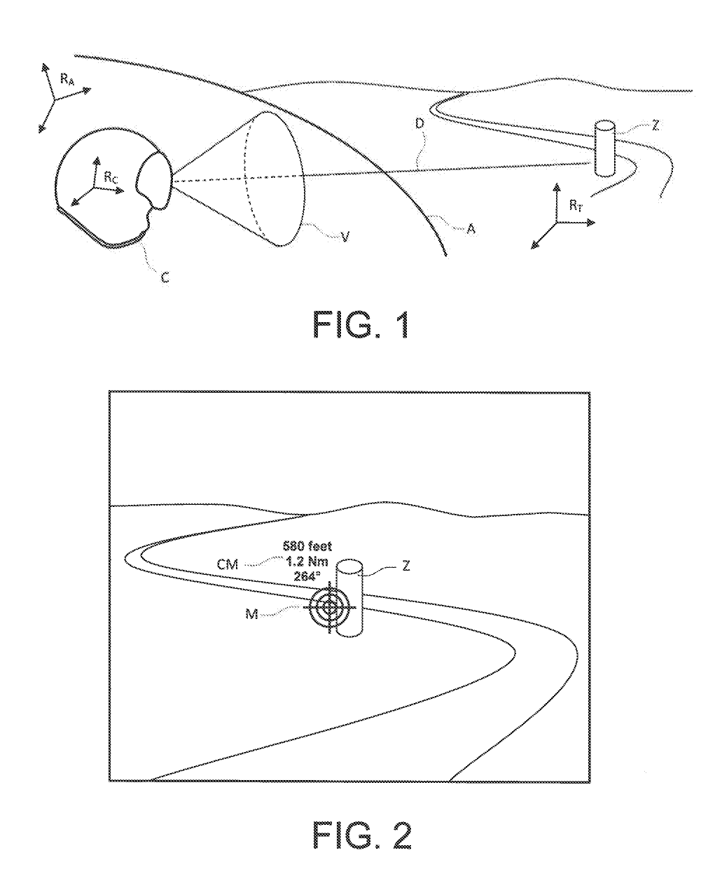

FIG. 1 represents the general operation of the system according to the invention;

FIG. 2 represents a first representation of the marking symbol in a helmet display device;

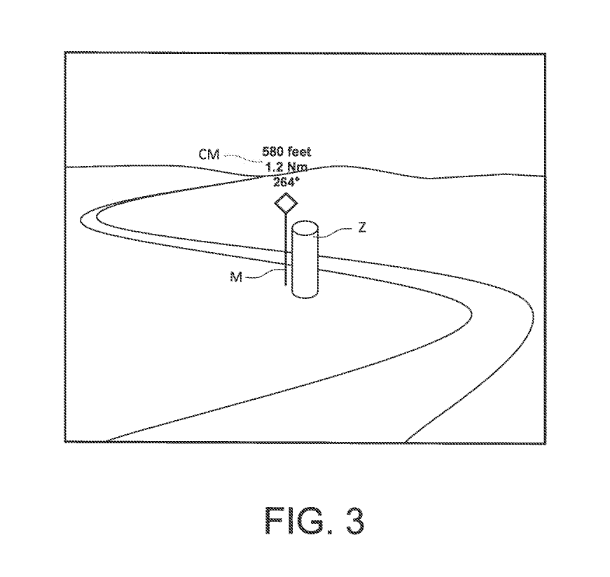

FIG. 3 represents a second representation of the marking symbol in a helmet display device.

The avionics system according to the invention comprises at least one display system and one navigation system.

The display system comprises a helmet or a head support equipped with a display device capable of generating images overlaid on said terrain, and a system for detecting posture of said helmet or of said support in said aircraft.

A head display system mainly comprises:
an equipped helmet or head support comprising an optoelectronic display assembly. This assembly can be monocular or binocular. When the helmet or the support is worn by a user, this assembly gives a collimated image deriving from a display and overlaid on the outside landscape by an optical combiner or mixer which can be incorporated or not in a visor;
a system for detecting posture of the helmet or of the support making it possible to determine the position and the orientation of the helmet in the reference frame of the aircraft. There are various detection systems which are well known to those skilled in the art. The magnetic detection systems in which a receiver measures the components of a known electromagnetic field and the optical detection systems comprising an emitter and a receiver capable of determining the position and the orientation of this emitter by shape recognition will be cited. The position of the aircraft in a terrestrial reference frame is itself known by means of different sensors such as the inertial unit of the aircraft.

The navigation system comprises at least geolocation means for said aircraft of the “GPS” (Global Positioning System) type, a database of cartographic data representative of the terrain and an electronic computer. This electronic computer ensures a number of functions detailed below.

The first function of the electronic computer is to ensure the generation of a conformal symbology overlaid on the outside landscape by the optoelectronic display assembly. This symbology generally comprises the basic information necessary to the piloting such as the velocity, altitude or trim indications. To ensure this function, the various sensors of the aircraft supply the computer with the necessary information. The system for detecting orientation of the helmet gives it the position and orientation information making it possible to display the symbology conformally, that is to say in a terrestrial reference frame independent of the movements of the aircraft and of the movements of the helmet.

The second function of the computer, and the one which is more particularly dedicated to the implementation of the invention, is a terrain marking function. It comprises a number of aspects. The first aspect of this function is to generate, on command from the user, in the helmet display device, a marking symbol, said symbol determining a given direction.

This symbol can have different representations. By way of nonlimiting examples, it can have a simple geometrical shape like a circle, a square, a rhomboid or even a cross or a more sophisticated shape like a target comprising a number of concentric circles centered on a cross. It is also possible to show the symbol highlighted.

When the marking symbol is in the visual field of the user, the latter can then overlay it on an area or a particular object of the terrain being flown over by a simple head movement. The navigation system comprises computation means making it possible to determine the location of the area of the terrain arranged at the intersection of said given direction with said terrain.

The computation principle is represented in FIG. 1. The terrain is referenced in a perfectly known terrestrial reference frame R_{T}. The aircraft A is referenced in a moving reference frame R_{A}. The posture of the helmet C is referenced in a moving reference frame R_{C}. The helmet visual field V is represented by a cone in FIG. 1. At each instant, it is possible to compute the posture of the helmet in the reference frame of the aircraft R_{A} by means of the posture detection system, then, by means of the aircraft geolocation system, the posture of the helmet in the terrestrial reference frame R_{T}. Consequently, the direction D indicated by the marking symbol is perfectly known in the terrestrial reference frame. It is then easy, knowing the position of the aircraft in relation to the terrain being flown over, to compute the intersection of this direction with the terrain by means of the cartographic database and determine the location of the terrain area “marked” by the marking symbol. In FIG. 1, this area is symbolized by a cylindrical tower Z.

The processing means then determine the information on position, altitude and distance to the aircraft from the located terrain area. This information can be displayed in an inset near the marking symbol. As an example, FIG. 2 represents the marking symbology in the preceding configuration seen by the pilot in his or her helmet display device. The marking symbol M is a target in this FIG. 2. The inset CM comprises the three indications “580 feet”, “1.2 Nm” and “264°” corresponding respectively to the altitude in feet, to the distance in nautical miles and to the heading in degrees of the selected area.

The user can then validate the marking by means of an appropriate command. It is then advantageous to change the graphic representation of the marking symbol to indicate its change of state. As an example, FIG. 3 illustrates this change of state. Once validated, the marking symbol M is a vertical line topped by a white rhomboid. After validation, the marking symbol is associated with the located terrain area.

The computer comprises means for recording and processing said location in the navigation system. As a first example, the navigation system can insert it into a flight plan. As a second example, the navigation system computes a homing trajectory to said located terrain area. Finally, the navigation system can display it in at least one cartographic representation of the terrain being flown over of a second display device of the display system. This second device can be one of the display devices of the instrument panel.

None of these electronic functions pose any particular production difficulties for those skilled in the art.

1. An avionics system intended to be used on aircraft in flight above a terrain, said avionics system comprising a display system and a navigation system,
said display system comprising at least one head support or a helmet equipped with a display device capable of generating images overlaid on said terrain, and a system for detecting posture of said helmet or of said support in said aircraft;
said navigation system comprising at least geolocation means for said aircraft, and a database of cartographic data representative of said terrain;
wherein:
the display system comprises means for displaying a marking symbol (M) in the display device, said symbol determining a given direction;
the navigation system comprises computation means making it possible to determine the location of the area of the terrain arranged at the intersection of said given direction with said terrain, and means for recording and processing said location in the navigation system;
the display system comprises marking validation means, the graphic representation of the marking symbol being modified after validation, said marking symbol being associated, after validation, with said located terrain area;
when the located terrain area is validated, the navigation system inserts it into a flight plan.

2. The avionics system as claimed in claim 1, wherein the processing means determine the information on position, altitude and distance to the aircraft from the located terrain area, said information (CM) being displayed in the display device at the level of the marking symbol.

3. The avionics system as claimed in claim 1, wherein, when the located terrain area is validated, the navigation system computes a homing trajectory to said located terrain area.

4. The avionics system as claimed in claim 1, wherein, when the located terrain area is validated, the navigation system displays it in at least one cartographic representation of the terrain being flown over of a second display device of the display system.
